(19) United States
(12) Patent Application Publication
(10) Pub. No.: US 2010/0159896 A1
(43) Pub. Date: Jun. 24, 2010

(54) APPARATUS AND METHOD FOR DYNAMICALLY DISPLAYING SERVICES RECOMMENDED BASED ON CONTEXT-AWARENESS IN MOBILE TERMINAL

(75) Inventors: Young-mee SHIN, Daejeon-si (KR); Sang-ki Kim, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/550,794

(22) Filed: Aug. 31, 2009

(30) Foreign Application Priority Data
Dec. 19, 2008 (KR) 10-2008-130633

(51) Int. Cl. H04M 3/42

(52) U.S. Cl. 455/414.1

(57) ABSTRACT

Disclosed is a technology of dynamically displaying services recommended based on context-awareness. A mobile terminal suitable for dynamically displaying services recommended based on context-awareness includes: a notice information receiver to receive value-added service notice information regarding at least one recommended value-added service from a value-added service recommending server; a menu processor to acquire value-added service information associated with the value-added service notice information from stored value-added service information, determine menus to be displayed according to the acquired value-added service information and display the menus on a screen; and a value-added service output unit to receive, when a menu is selected from the displayed menus, a value-added service associated with the menu from an application server and output the value-added service on the screen.

### CROSS-REFERENCE TO RELATED APPLICATION

This application claims the benefit under 35 U.S.C. §119(a) of Korean Patent Application No. 10-2008-130633, filed on Dec. 19, 2008, the disclosure of which is incorporated by reference in its entirety for all purposes.

### BACKGROUND

1. Field

The following description relates to a technology of using IP multimedia subsystem (IMS)-based value-added services, and more particularly, to an apparatus and method for dynamically displaying services recommended based on context-awareness in a mobile terminal.

2. Description of the Related Art

User interface technologies for mobile terminals, such as a mobile phone, a smart phone and a personal digital assistant (PDA) are following the trend of providing icons from providing static menus. Also, following with the development of telecommunication technologies, in addition to providing telecommunication services, the provision of value-added services for mobile terminals via a telecommunication network is further increasing.

However, there is limitation in displaying on the screen of a mobile terminal all of basic applications of the mobile terminal, basic services provided by telecommunication networks, and applications for value-added services with which the mobile terminal's user has subscribed. Also, as applications for mobile terminal are becoming more complex than ever, it is becoming more inconvenient for users to select a desired one of such complex applications.

In order to resolve these problems, a mobile terminal has been developed which can dynamically configure menus of applications based on analysis of the user's usage pattern of the applications. The mobile terminal analyzes a pattern of a user's behaviors and reconfigures menus of applications dynamically based on the results of the analysis. However, the conventional technology considers a user's tendencies only temporally and geographically without taking user's context, service pre-conditions, and service life cycles into consideration.

For these reasons, studies into how to effectively arrange application menus and value-added service menus on a limited screen of a mobile terminal have taken place. However, the related conventional technologies have focused on configuring menus on the screen of a mobile terminal according to simple criteria such as a pattern of the user's behavior. In addition, the conventional technologies do not consider the case of adding new menus, and furthermore have significantly low use efficiency since, upon reconfiguration, they reconfigure all the menus including even menus which have a low frequency of use.

### SUMMARY

The following description is directed to displaying on a mobile terminal only available services based on context-awareness.

The following description is also directed to informing non-available services based on context-awareness to facilitate service access of a mobile terminal.

The following description is also directed to making a mobile terminal classify and store value-added services-related information automatically.

The following description is also directed to ensuring convenient use of application menus or value-added service menus of a mobile terminal.

According to an exemplary aspect, there is provided a mobile terminal which receives personalized services based on context-awareness, including: a notice information receiver to receive value-added service notice information regarding at least one recommended value-added service from a value-added service recommending server; a menu processor to acquire value-added service information associated with the value-added service notice information from stored value-added service information, determine menus to be displayed according to the acquired value-added service information, and display the determined menus on a screen of the mobile terminal; and a value-added service output unit to receive, when a menu is selected from the displayed menus, a value-added service associated with the menu from an application server and output the value-added service on the screen.

The mobile terminal further includes a value-added service information storage to store the value-added service information therein, wherein the value-added service information includes client application program of the value-added service, menu like icon associated with the client application program, and information about display state of the menu indicating whether the menu have been displayed, and the value-added service notice information received from the value-added service recommending server includes at least one piece of information from information indicating available value-added services, information indicating non-available value-added services, value-added service deletion information and value-added service update information.

The mobile terminal further includes a value-added service determining unit to determine which value-added service is associated with the value-added service notice information received from the notice information receiver.

Therefore, the mobile terminal checks the display states of menus associated with value-added service information according to value-added service notice information received from a value-added service recommending server, and displays the menus depending on the result of the determination.

If the value-added service determining unit determines that the value-added service notice information is associated with the available value-added services, the menu processor includes: an application program checking unit to determine whether any client application program is associated with the available value-added services among the client application programs of the plurality of value-added services stored in the value-added service information storage; a menu checking unit to acquire, if there are client application programs associated with the available value-added services, menus associated with the client application programs, and determine whether the menus have already been displayed on the screen, based on information about display states of the menus; and a menu highlighting unit to highlight, if some of the menus have already been on the screen, the menus, and if some of the menus have not been displayed on the screen, display the menus on the screen and then highlight the menus after updating the information about the display states of the menus.

The menu processor includes: a virtual menu creator to create, if there is no client application program associated with the available value-added services, virtual menus and display the virtual menus on the screen; a virtual menu execution unit to receive and install, if a virtual menu displayed on the screen is selected, a client application program associated with the selected available value-added service from the application server, convert the virtual menu into a new menu associated with the installed client application program, and display the new menu on the screen through the menu highlighting unit; and a new value-added service information processor to store new value-added service information including the new menu and the client application program in the value-added service information storage.

If the value-added service determining unit determines that the value-added service notice information is associated with the non-available value-added services, the menu processor includes: an application program checking unit to determine whether any client application program is associated with the non-available value-added services among the client application programs of the plurality of value-added services stored in the value-added service information storage; a menu checking unit to acquire, if there are client application programs associated with the non-available value-added services, menus associated with the client application programs, and determine whether the menus have been displayed on the screen, based on information about display states of the menus; and a menu state converting unit to delete, if some of the menus associated with the non-available value-added services have been displayed on the screen, the menus from the screen.

Accordingly, the mobile terminal displays only menus of available value-added services on a screen to allow the user to easily and conveniently use value-added services.

If the value-added service determining unit determines that the value-added service notice information is the value-added service deletion information, the menu processor includes: an application program checking unit to determine whether any client application program is associated with the value-added service deletion information among the client application programs of the plurality of value-added services stored in the value-added service information storage; a menu checking unit to acquire, if there are client application programs associated with the value-added service deletion information, menus associated with the client application programs, and determine whether the menus have been displayed on the screen, based on information about display states of the menus; and a menu deletion unit to delete, if some of the menus associated with the value-added service deletion information have been displayed on the screen, the menus from the screen, delete value-added service information associated with the menu, and if some of the menus associated with the value-added service deletion information have not been displayed on the screen, only delete the value-added service information associated with the value-added service deletion information.

If the value-added service determining unit determines that the value-added service notice information is the value-added service update information, the menu processor includes: an application program checking unit to determine whether any client application program is associated with the value-added service update information among the client application programs of the plurality of value-added services stored in the value-added service information storage; and a value-added service update unit to update, if there are client application programs associated with the value-added service update information, the client application programs.

Therefore, the mobile terminal may itself delete or update value-added service-related information installed therein.

The apparatus and method for dynamically displaying services recommended based on context-awareness display only a list of available services based on context-awareness, thereby allowing the user to easily access desired services. Accordingly, a service provider who provides services may ensure that users frequently use the services.

Furthermore, the mobile terminal allows users to easily check menus of value-added services while eliminating the need for manual manipulations to update the menus, by automatically classifying and updating the value-added service menus on a screen of the mobile terminal.

Other objects, features and advantages will be apparent from the following description, the drawings, and the claims.

### BRIEF DESCRIPTION OF THE DRAWINGS

FIG. 1 is a block diagram illustrating a configuration of a system of providing personalized services based on context-awareness, according to an exemplary embodiment.

FIG. 2 is a block diagram illustrating a mobile terminal of providing personalized services based on context-awareness, according to an exemplary embodiment.

FIG. 3 is a flowchart illustrating a method of providing personalized services based on context-awareness, according to an exemplary embodiment.

FIG. 4 is a flowchart illustrating a method of determining, when value-added service notice information is associated with available value-added services, whether menus associated with corresponding value-added service information have already been displayed, according to an exemplary embodiment.

FIG. 5 is a flowchart illustrating a method of determining, when value-added service notice information is associated with non-available value-added services, whether menus associated with corresponding value-added service information have been displayed, according to an exemplary embodiment.

FIG. 6 is a flowchart illustrating a method of determining, when value-added service notice information is value-added service deletion information, whether a menu associated with corresponding value-added service information has been displayed, according to an exemplary embodiment.

FIG. 7 is a flowchart illustrating a method of determining, when value-added service notice information is value-added service update information, whether a menu associated with corresponding value-added service information has already been displayed, according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

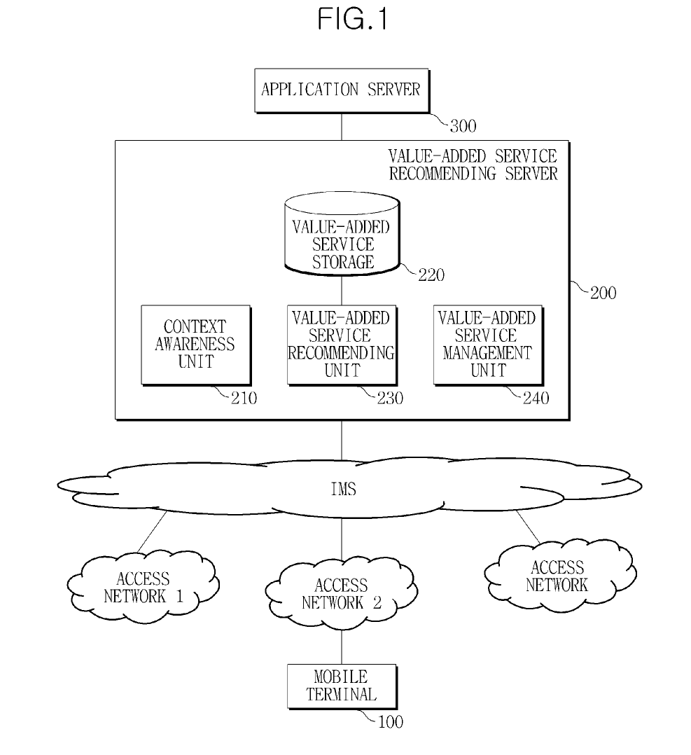

FIG. 1 is a block diagram illustrating a configuration of a system of providing personalized services based on context-awareness, according to an exemplary embodiment.

Referring to FIG. 1, the system includes a mobile terminal 100, a value-added service recommending server 200 and an application server 300.

The mobile terminal 100 may be a mobile phone, a smart phone or a personal digital assistant (PAD). The mobile terminal 100 may support various value-added services (for example, watching television) that are provided by the application server 300 through access networks and IP Multimedia Subsystem (IMS). In order for a user to use value-added services provided by the application server 300, the mobile terminal 100 installs client application programs for the value-added services therein and displays menus associated with the installed application programs on a screen.

Then, when the user selects one of the menus displayed on the screen of the mobile terminal 100, the user can receive a value-added service associated with the selected menu from the application server 300.

Meanwhile, the value-added service recommending server 200 recommends value-added services according to the user's context. That is, the value-added service recommending server 200 identifies information about the user's context received from the mobile terminal 100, and transmits a list of available or non-available value-added services to the mobile terminal 100 according to the result of the identification. Also, the value-added service recommending server 200 periodically checks the state of the application server 300, along with the user's context, to determine value-added services as being providable or unprovidable by the application server 300, and transmits a list of providable or unprovidable value-added services to the mobile terminal 100. The value-added service recommending server 200 may provide value-added services based on the user's context through a context aware unit 210, a value-added service storage 220 and a value-added service recommending unit 230.

The context awareness unit 210 collects information about the user's context from various sources, such as the mobile terminal 100 and IMS. The value-added service storage 220 stores information about pre-conditions to provide value-added services, including location information, access time, etc. of the mobile terminal 100.

The value-added service recommending unit 230 creates a list of value-added services suitable for the user's current context and transmits the list of value-added services to the mobile terminal 100. That is, the value-added service recommending unit 230 extracts, when receiving information about the user's context from the mobile terminal 100 through the context awareness unit 210, a list of available or non-available value-added services from the value-added service storage 220 based on the information about the user's context, and transmits the list of available or non-available value-added services to the mobile terminal 100. Accordingly, if a list of available or non-available value-added services is displayed on the screen of the mobile terminal 100, the user may select a desired value-added service while viewing the list.

Meanwhile, the value-added service recommending server 200 further includes a value-added service manager 240. The value-added service manager 240, which manages the updating of value-added services with respect to the application server 300, checks what value-added services have been deleted from or updated to the application server 300. That is, if it is checked that at least one of a plurality of value-added services provided by the application server 300 has been deleted or updated, the value-added service manager 240 transmits information about the deleted or updated application service to the mobile terminal 100. Thereafter, the mobile terminal 100 deletes or update value-added service information associated with the corresponding value-added service. In this way, the mobile terminal 100 can dynamically manage value-added service information stored therein, thereby eliminating the need for the user to have to directly classify and update many value-added service-related client application programs and menus.

So far, the components of the system of providing personalized services based on context-awareness have been described in detail. Hereinafter, the mobile terminal 100 suitable for providing personalized services based on context-awareness will be described in detail.

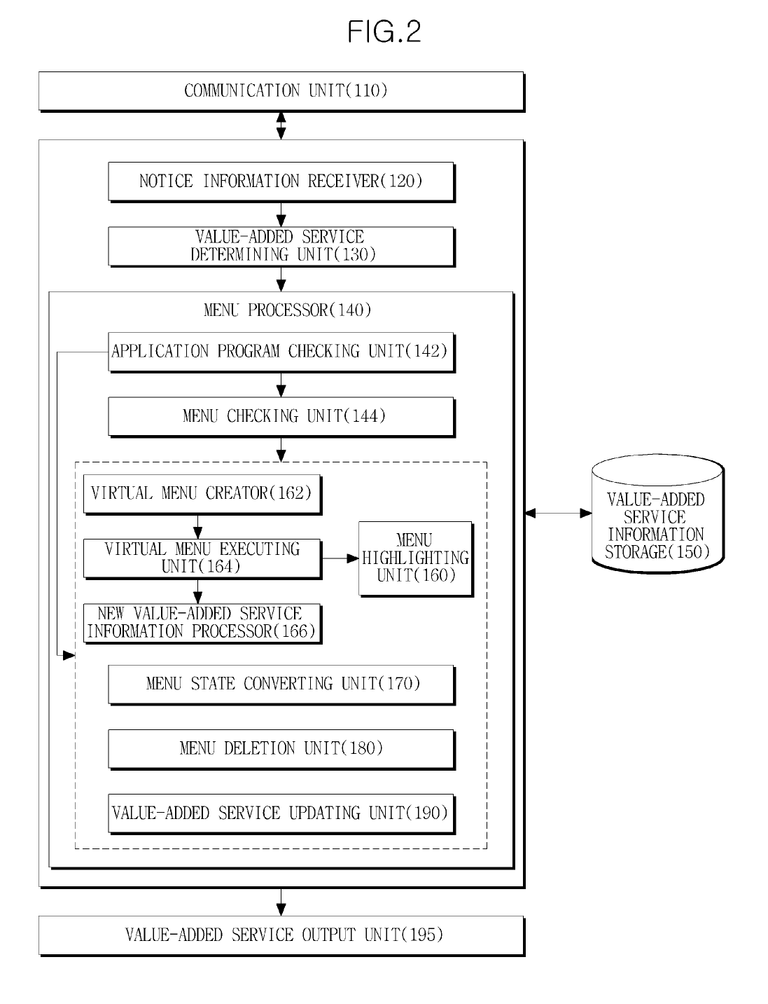

FIG. 2 is a block diagram illustrating the mobile terminal 100 suitable for providing personalized services based on context-awareness, according to an exemplary embodiment.

Referring to FIG. 2, the mobile terminal 100 includes a communication unit 110, a notice information receiver 120, a value-added service determining unit 130, a menu processor 140, a value-added service information storage 150 and a value-added service output unit 195.

The communication unit 110 communicates with a value-added service recommending server 200 and an application server 300 (see FIG. 1) in order to receive value-added services. The notice information receiver 120 receives value-added service notice information associated with a plurality of value-added services from the value-added service recommending server 200 through the communication unit 110. The value-added service notice information may be at least one of information indicating available value-added services, information indicating non-available value-added services, information indicating value-added services for deletion (hereinafter, “value-added services deletion information”) and information indicating value-added services for updating (hereinafter, “value-added services update information”).

The value-added service determining unit 130 determines which value-added service is associated with the value-added service notice information received from the notice information receiver 120. That is, the value-added service determining unit 130 determines, as described above, when receiving value-added service notice information from the notice information receiver 120, which one of available value-added services, non-available value-added services, value-added service deletion information and value-added service update information is associated with the value-added service notice information.

The menu processor 140 determines which menus to display based on service information determined by the value-added service determining unit 130 with reference to value-added service information stored in the value-added service information storage 150 which will be described later. Here, the value-added service information includes client application program of each value-added service, menu associated with the client application program, and information about display state of the menu indicating whether the menu have been displayed.

If a menu is determined to be displayed on the screen by the menu processor 140 and the menu is selected, the value-added service display unit 195 receives a value-added service corresponding to the selected menu from the application server 300 and outputs the value-added service on the screen.

Meanwhile, the menu processor 140 processes the corresponding value-added service information stored in the value-added service information storage 150 according to the service information determined by the value-added service determining unit 130.

According to an exemplary embodiment, if the value-added service determining unit 130 determines that the value-added service notice information is associated with available value-added services, the menu processor 140 displays menus associated with available value-added services on the screen through an application program checking unit 142, a menu checking unit 144 and a menu highlighting unit 160. The application program checking unit 142 determines whether any client application program is associated with available value-added services among client application programs of value-added services stored in the value-added service information storage 150. If there are client application programs associated with available value-added services, the menu checking unit 144 acquires menus associated with the client application programs, and determines whether the menus have already been displayed on the screen, based on information about display states of the menus.

If some of the menus have already been displayed on the screen, the menu highlighting unit 160 highlights the menus displayed on the screen.

For example, the menu may blink in order for the user to easily find the menu on the screen. Meanwhile, if some of the menus have not been displayed on the screen, the menu highlighting unit 160 displays the menus and then highlights the menus after updating the information about the display states of the menus.

Accordingly, the user can select a desired menu while viewing only menus associated with available value-added services on the screen of the mobile terminal 100 to use a desired value-added service.

Meanwhile, if there is no client application program associated with the available value-added services, the menu processor 140 receives client application programs from the application server 300 through a virtual menu creator 162 and a virtual menu execution unit 164. That is, if there is no client application program associated with available value-added services, the virtual menu creator 162 creates virtual menus and displays the virtual menus on the screen. Then, if a virtual menu displayed on the screen is selected, the virtual menu execution unit 164 receives a client application program associated with the selected available value-added service from the application server 300. Then, the virtual menu execution unit 164 installs the received client application program, and converts the virtual menu displayed on the screen into a new menu associated with the installed client application program.

Thereafter, the menu highlighting unit 160, as described above, highlights the new menu displayed on the screen.

Meanwhile, if a new client application is executed and a new menu associated with the new client application is created by the virtual menu execution unit 164, a new value-added service information processor 166 stores new value-added service information including the new client application program and the new menu in the value-added service information storage 150. Accordingly, when no client application program associated with available value-added services is found, the mobile terminal 100 may automatically install a client application program associated with available value-added services.

According to another exemplary embodiment, if the value-added service determining unit 130 determines that the value-added service notice information is associated with non-available value-added services, the menu processor 140 deletes a menu associated with the non-available value-added services from the screen through the application program checking unit 142, the menu checking unit 144 and a menu state converting unit 170. The application program checking unit 142 determines whether any client application program is associated with non-available value-added services among the client application programs of the value-added services stored in the value-added service information storage 150. If there are client application programs associated with non-available value-added services, the menu checking unit 144 acquires menus associated with the client application programs, and determines whether the menus have been displayed on the screen, based on information about display states of the menus. If some of the menus associated with the available value-added services have been displayed on the screen, the menu state converting unit 170 deletes the menus from the screen.

Accordingly, the user may select a desired menu while viewing only menus associated with available value-added services through the screen of the mobile terminal 100.

According to another exemplary embodiment, if the value-added service determining unit 130 determines that the value-added service notice information is value-added service deletion information, the menu processor 140 deletes a menu associated with the value-added service deletion information and also value-added service information associated with the menu through the application program checking unit 142, the menu checking unit 144 and a menu deletion unit 180. The application program checking unit 142 determines whether any client application program is associated with the value-added service deletion information among the client application programs of the value-added services stored in the value-added service information storage 150. If there are client application programs associated with the value-added service deletion information, the menu checking unit 144 acquires menus associated with the client application programs, and determines whether the menus have been displayed, based on information about display states of the menus. If some of the menus associated with the value-added service deletion information have been displayed on the screen, the menu deletion unit 180 deletes the menus displayed on the screen and also deletes value-added service information associated with the menus from the value-added service information storage 150. However, if some of the menus associated with the value-added service deletion information have not been displayed on the screen, the menu deletion unit 180 extracts and deletes value-added service information associated with menus which have not displayed on the screen.

In this way, since the mobile terminal 100 automatically deletes unnecessary menus and value-added service information associated with the menus, the user does not need to, himself or herself, classify and store value-added service-related information stored in the mobile terminal 100.

According to another exemplary embodiment, if the value-added service determining unit 130 determines that the value-added service notice information is value-added service update information, the menu processor 140 updates a client application program associated with the value-added service update information and value-added service information associated with the client application program through the application program checking unit 142 and a value-added service updating unit 190. The application program checking unit 142 determines whether any client application program is associated with the value-added service update information among the client application programs of the value-added services stored in the value-added service information storage 150. If there are client application programs associated with the value-added service update information, the value-added service updating unit 190 updates the client application programs and value-added service information associated with the client application programs.

As such, since the mobile terminal 100 itself updates value-added service information stored in the value-added service information storage 150 to allow the user to conveniently use value-added services provided by the application server 300, the user does not need to update value-added service-related information stored in the mobile terminal 100.

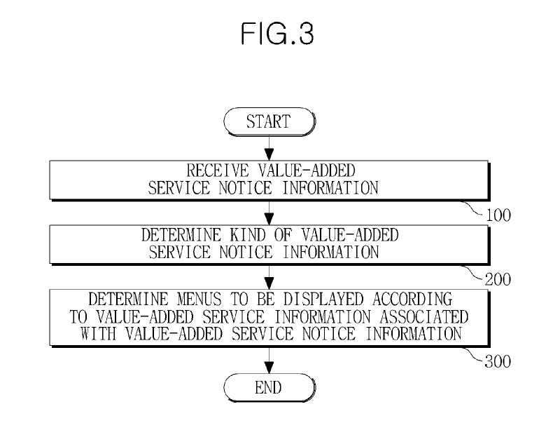

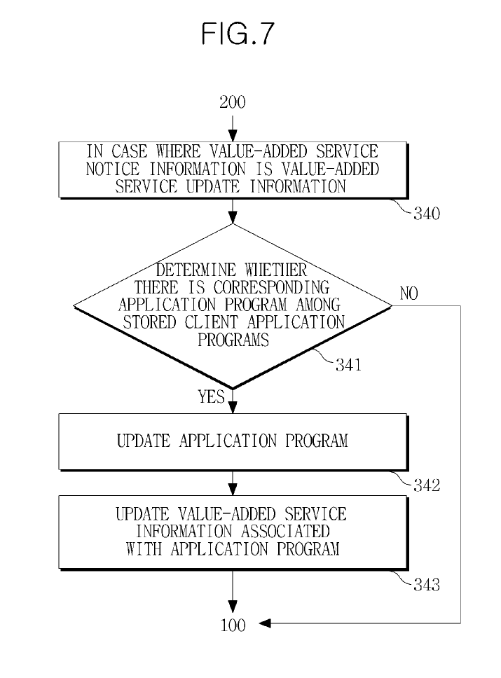

Hereinafter, a method by which the mobile terminal 100 provides personalized services based on context-awareness will be described in detail with reference to FIGS. 3 and 7.

FIG. 3 is a flowchart illustrating a method of providing personalized services based on context-awareness, according to an exemplary embodiment.

Referring to FIGS. 1 and 3, the mobile terminal 100 receives value-added service notice information associated with a plurality of value-added services provided by the application server 300 from the value-added service recommending server 200 (operation 100). Here, the value-added service notice information may be at least one piece of information from information indicating available value-added services, information indicating non-available value-added services, value-added service deletion information and value-added service update information.

When receiving such value-added service notice information from the value-added service recommending server 200, the mobile terminal 100 determines which value-added service information is associated with the value-added service notice information. That is, the mobile terminal 100 determines, when receiving value-added service notice information, which value-added service information of information regarding available value-added services, information regarding non-available value-added services, value-added service deletion information and value-added service update information is associated with the received value-added service notice information (operation 200).

Then, the mobile terminal 100 acquires value-added service information associated with the value-added service notice information from the value-added service information stored in the value-added service storage 150, and determines menus to be displayed according to the acquired value-added service information (operation 300). Here, the value-added service information stored in the value-added service storage 150 includes client application program of the corresponding value-added service, menu associated with the client application program and information about display state of the menu.

Then, the mobile terminal 100 processes the menus and receives any new value-added service notice information from the value-added service recommending server 200.

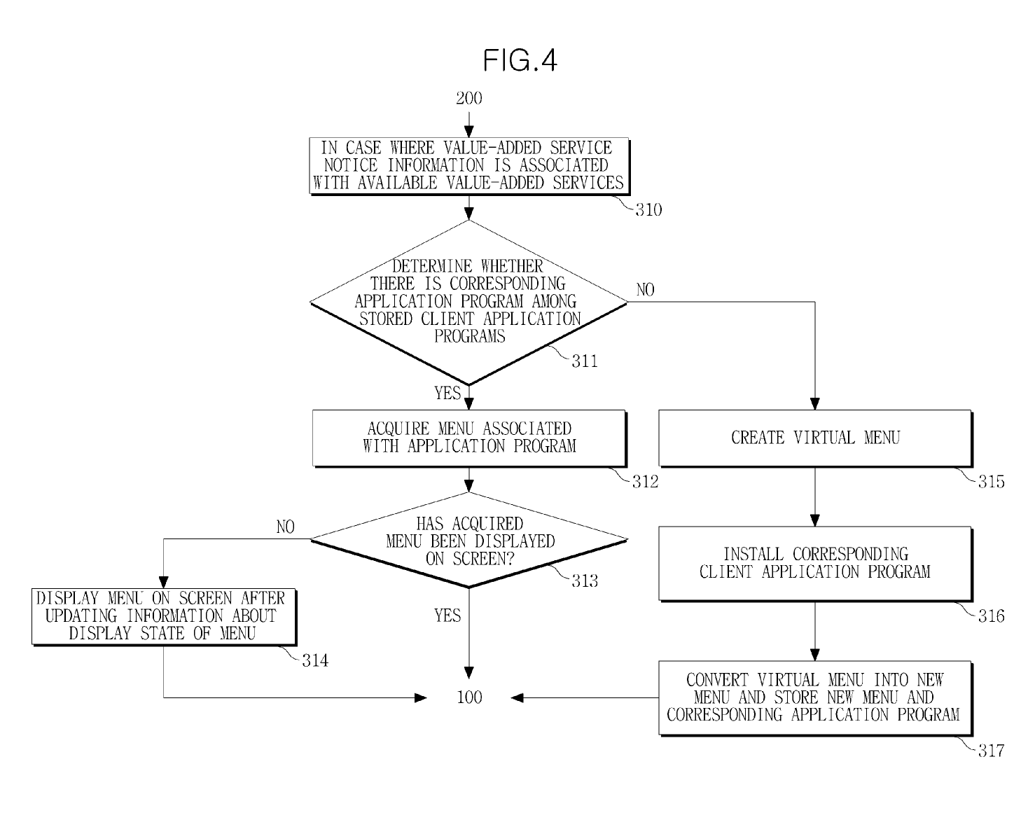

The method of determines menus to display based on value-added service information according to value-added service notice information will be described in more detail with reference to FIGS. 4 through 7, below.

Referring to FIGS. 1 and 4, if value-added service notice information received from the value-added service recommending server 200 is associated with available value-added services (operation 310), the mobile terminal 100 determines whether any client application program is associated with available value-added services among the client application programs included in the value-added service information stored in the value-added service information storage 150 (operation 311). If there is a client application program associated with available value-added services, the mobile terminal 100 acquires a menu associated with the client application program from the value-added service information storage 150 (operation 312). If the menu has already been displayed on the screen, the mobile terminal 100 highlights the menu.

For example, the menu may blink in order for a user to easily find the menu on the screen. Then, the process returns to operation 100 for the mobile terminal 100 to receive any new value-added service notice information from the value-added service recommending server 200.

Meanwhile, if the menu has not been displayed on the screen, the mobile terminal 100 displays the menu on the screen after updating information about a display state of the menu (operation 314). At this time, as described above, the menu may be highlighted, by for example blinking.

Accordingly, the user can select a desired menu on the screen of the mobile terminal 100 while viewing only menus associated with available value-added service to use a value-added service.

Meanwhile, if it is determined in operation 311 that there is no client application program associated with available value-added services, the mobile terminal 100 creates a virtual menu and displays the virtual menu on the screen. Then, if the virtual menu is selected by a user, the mobile terminal 100 informs the user that a new client application program has to be installed to execute the virtual menu. If the user requests installation of the virtual menu, the mobile terminal 100 accesses a Uniform Resource Locator (URL) of an application server, and receives and installs the corresponding client application program (operation 316). If the installation of the client application program is completed, the mobile terminal 100 converts the virtual menu into a new menu associated with the installed client application program. Then, the mobile terminal 100 stores new value-added service information including the new menu and the new client application program in the value-added service storage (operation 317). Then, the mobile terminal 100, as described above, highlights the new menu, and then the process returns to operation 100 for the mobile terminal 100 to receive any new value-added service notice information from the value-added service recommending server 200.

Accordingly, the user can view only menus associated with available value-added services on the screen of the mobile terminal 100.

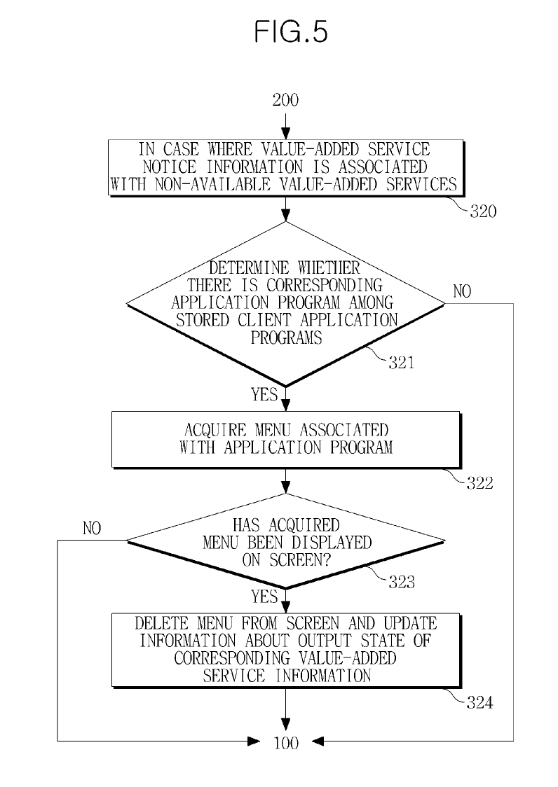

FIG. 5 is a flowchart illustrating a method of determining, when value-added service notice information is associated with non-available value-added services, whether menus associated with corresponding value-added service information have been displayed, according to an exemplary embodiment.

Referring to FIGS. 1 and 5, if the value-added service notice information received from the value-added service recommending server 200 is associated with non-available value-added services (operation 320), the mobile terminal 100 determines whether any client application program is associated with non-available value-added services among the client application programs of the value-added service information stored in the value-added service storage 150 (operation 321). Here, the non-available value-added services may be temporary value-added services or value-added services that have not been used for a long time.

If there is no client application program associated with non-available value-added services, the process returns to operation 100 for the mobile terminal 100 to receive any new value-added service notice information from the value-added service recommending server 200. If there is a client application program associated with non-available value-added services, the mobile terminal 100 acquires a menu associated with the client application program from the value-added service storage 150 (operation 322). Then, the mobile terminal 100 determines whether the menu has been displayed on the screen of the mobile terminal 100, based on information about a display state of the menu (operation 323). If the menu has not been displayed on the screen, the process returns to operation 100 for the mobile terminal 100 to receive any new value-added service notice information from the value-added service recommending server 200.

Meanwhile, if the menu has been displayed on the screen, the mobile terminal 100 deletes the menu from the screen, and updates information about a display state of value-added service information associated with the deleted menu (operation 324). Then, the process returns to operation 100 for the mobile terminal 100 to receive any new value-added service notice information from the value-added service recommending server 200.

Accordingly, the screen of the mobile terminal 100 displays only menus associated with available value-added services in order for the user to select a desired menu without wasting time by selecting non-available menus.

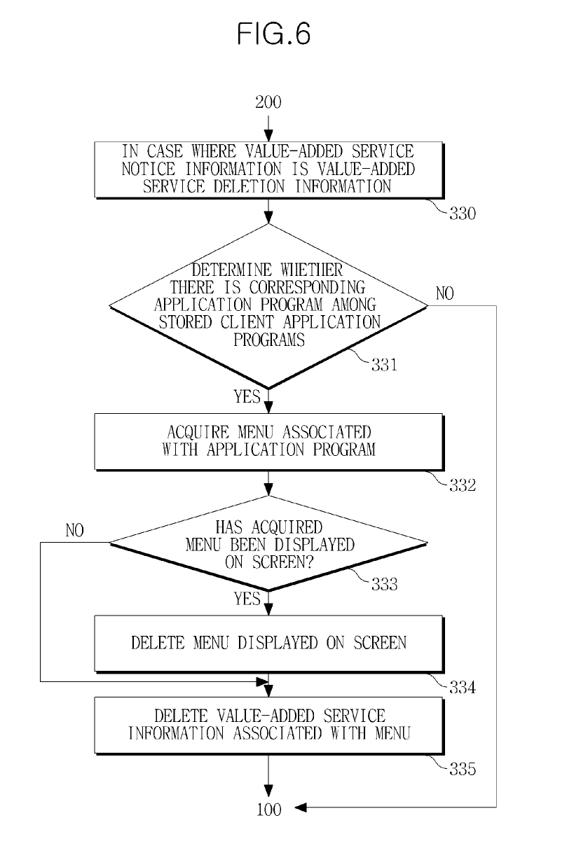

FIG. 6 is a flowchart illustrating a method of determining, when value-added service notice information is value-added service deletion information, whether a menu associated with corresponding value-added service information has been displayed, according to an exemplary embodiment.

Referring to FIGS. 1 and 6, if the value-added service notice information received from the value-added service recommending server 200 is value-added service deletion information (operation 330), the mobile terminal 100 determines whether any client application program is associated with value-added service deletion information among the client application programs included in the value-added service information stored in the value-added service information storage 150 (operation 331). If there is no client application program associated with value-added service deletion information, the process returns to operation 100, and if there is a client application program associated with value-added service deletion information, the mobile terminal 100 acquires information on a menu associated with the client application program from the value-added service informant storage 150 (operation 332). Then, the mobile terminal 100 determines whether the menu has been displayed on the screen of the mobile terminal 100, based on information about a display state of the menu (operation 333).

If the menu has been displayed on the screen, the mobile terminal 100 deletes the menu from the screen (operation 334) and also deletes all value-added service information associated with the menu (operation 335). Then, the process returns to operation 100 for the mobile terminal 100 to receive any new value-added service notice information from the value-added service recommending server 200. Meanwhile, if the menu has not been displayed on the screen, the mobile terminal 100 deletes value-added service information associated with the menu from the value-added service information storage 150, and then the process returns to operation 100 for the mobile terminal 100 to receive any new value-added service notice information from the value-added service recommending server 200.

In this way, since the mobile terminal 100 deletes unnecessary menus and value-added service information associated with the menus automatically, the user does not need to, himself or herself, classify and store value-added service-related information stored in the mobile terminal 100.

FIG. 7 is a flowchart illustrating a method of determining, when value-added service notice information is value-added service update information, whether a menu associated with value-added service information has been displayed, according to an exemplary embodiment.

Referring to FIGS. 1 and 7, if the value-added service notice information received from the value-added service recommending server 200 is value-added service update information (operation 340), the mobile terminal 100 determines whether any client application program is associated with value-added service update information among the client application programs of the value-added service information stored in the value-added service information storage 150 (operation 341). If there is no client application program associated with value-added service update information, the process returns to operation 100, and if there is a client application program associated with value-added service update information, the mobile terminal 100 informs the user that the corresponding client application program has to be updated.

Accordingly, if the user requests the mobile terminal 100 to update the client application program, the mobile terminal 100 accesses a URL of the application server 300, receives updated client application program from the application server 300 and then updates the client application program (operation 342). Then, the mobile terminal 100 updates value-added service information of the client application program stored in the value-added service information storage 150 (operation 343).

If the update of the client application program and value-added service information is completed, the process returns to operation 100 for the mobile terminal 100 to receive any new value-added service notice information. In this way, since the mobile terminal 100 automatically updates value-added service information stored in the value-added service information storage 150, the user can conveniently use value-added services provided by the application server 300.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A mobile terminal which receives personalized services based on context-awareness, comprising:
a notice information receiver to receive value-added service notice information regarding at least one recommended value-added service from a value-added service recommending server;
a menu processor to acquire value-added service information associated with the value-added service notice information from stored value-added service information, determine menus to be displayed according to the acquired value-added service information, and display the determined menus on a screen of the mobile terminal; and
a value-added service output unit to receive, when a menu is selected from the displayed menus, a value-added service associated with the selected menu from an application server and output the value-added service on the screen.

2. The mobile terminal of claim 1, further comprising a value-added service information storage to store the value-added service information therein,
wherein the value-added service information includes client application program of the value-added service, menu associated with the client application program, and information about display state of the menu indicating whether the menu have been displayed, and
the value-added service notice information received from the value-added service recommending server includes at least one piece of information from information indicating available value-added services, information indicating non-available value-added services, value-added service deletion information and value-added service update information.

3. The mobile terminal of claim 2, further comprising a value-added service determining unit to determine which value-added service is associated with the value-added service notice information received from the notice information receiver.

4. The mobile terminal of claim 3, wherein if the value-added service determining unit determines that the value-added service notice information is associated with the available value-added services, the menu processor comprises:
an application program checking unit to determine whether any client application program is associated with the available value-added services among the client application programs of the plurality of value-added services stored in the value-added service information storage;
a menu checking unit to acquire, if there are client application programs associated with the available value-added services, menus associated with the client application programs, and determine whether the menus have already been displayed on the screen, based on information about display states of the menus; and
a menu highlighting unit to highlight, if some of the menus have already been on the screen, the menus, and if some of the menus have not been displayed on the screen, display the menus on the screen and then highlight the menus after updating the information about the display states of the menus.

5. The mobile terminal of claim 4, wherein the menu processor comprises:
a virtual menu creator to create, if there is no client application program associated with the available value-added services, a virtual menu and display the virtual menu on the screen;
a virtual menu execution unit to receive and install, if the virtual menu displayed on the screen is selected, a client application program associated with the available value-added service from the application server, convert the virtual menu into a new menu associated with the installed client application program, and display the new menu on the screen through the menu highlighting unit; and
a new value-added service information processor to store new value-added service information including the new menu and the client application program in the value-added service information storage.

6. The mobile terminal of claim 3, wherein if the value-added service determining unit determines that the value-added service notice information is associated with the non-available value-added services, the menu processor comprises:
an application program checking unit to determine whether any client application program is associated with the non-available value-added services among the client application programs of the plurality of value-added services stored in the value-added service information storage;
a menu checking unit to acquire, if there are client application programs associated with the non-available value-added services, menus associated with the client application programs, and determine whether the menus have been displayed on the screen, based on information about display states of the menus; and
a menu state converting unit to delete, if some of the menus associated with the non-available value-added services have been displayed on the screen, the menus from the screen and update display states of the menus.

7. The mobile terminal of claim 3, wherein if the value-added service determining unit determines that the value-added service notice information is the value-added service deletion information, the menu processor comprises:
an application program checking unit to determine whether any client application program is associated with the value-added service deletion information among the client application programs of the plurality of value-added services stored in the value-added service information storage;
a menu checking unit to acquire, if there are client application programs associated with the value-added service deletion information, menus associated with the client application programs, and determine whether the menus have been displayed on the screen, based on information about display states of the menus; and
a menu deletion unit to delete, if some of the menus associated with the value-added service deletion information have been displayed on the screen, the menus from the screen, delete value-added service information associated with the menus, and if some of the menus associated with the value-added service deletion information have not been displayed on the screen, delete the value-added service information associated with the menus.

8. The mobile terminal of claim 3, wherein if the value-added service determining unit determines that the value-added service notice information is the value-added service update information, the menu processor comprises:
an application program checking unit to determine whether any client application program is associated with the value-added service update information among the client application programs of the plurality of value-added services stored in the value-added service information storage; and
a value-added service update unit to update, if there are client application programs associated with the value-added service update information, the client application programs.

9. A method of receiving personalized services based on context-awareness, comprising:
receiving, from a value-added service recommending server, value-added service notice information associated with at least one value-added service that are provided by an application server;
determining which value-added services are associated with the value-added service notice information; and
acquiring value-added service information associated with the determined value-added services, from value-added service information stored in a value-added service information storage, and determining menus to be displayed according to the acquired value-added service information.

10. The method of claim 9, wherein the value-added service information stored in the value-added service information storage includes client application program of the value-added service, menu associated with the client application program and information about display state of the menu indicating whether the menu has been displayed, and
the value-added service notice information received from the value-added service recommending server includes at least one piece of information from information indicating available value-added services, information indicating non-available value-added services, value-added service deletion information and value-added service update information.

11. The method of claim 10, wherein if it is determined that the value-added service notice information is associated with the available value-added services, the determining of the menus comprises:
determining whether there are client application programs associated with the available value-added services among the client application programs of the value-added service information stored in the value-added service information storage;
if there are client application programs associated with the available value-added services, acquiring menus associated with the client application programs from the value-added service information storage;
determining whether the menus have already been displayed on the screen, based on information about display states of the menus; and
if some of the menus have not been displayed on the screen, displaying the menus on the screen and highlighting the menus after updating the information about the display states of the menus, and if some of the menus have already been displayed on the screen, highlighting the menus displayed on the screen.

12. The method of claim 11, wherein the acquiring of the menu comprises:
if there is no client application program associated with the available value-added services, creating virtual menus associated with the available value-added services and displaying the virtual menus on the screen;
if a virtual menu is selected, receiving and installing a client application program associated with the selected value-added service from the application server; and
converting the virtual menu into a new menu associated with the installed client application program, and storing the new menu and the installed client application program as new value-added service information in the value-added service information storage.

13. The method of claim 10, wherein if it is determined that the value-added service notice information is associated with the non-available value-added services, the determining of the menus comprises:
determining whether there are client application program associated with the non-available value-added services among the client application programs of the plurality of pieces of value-added service information stored in the value-added service information storage;
if there are client application programs associated with the non-available value-added services, acquiring menus associated with the client application programs from the value-added service information storage;
determining whether the menus have been displayed on the screen, based on information about display states of the menus; and
if some of the menus have been displayed on the screen, deleting the menus from the screen and updating information about display states of the menus in value-added service information associated with the menus.

14. The method of claim 10, wherein if the value-added service notice information is the value-added service deletion information, the determining of the menus comprises:
determining whether there are client application programs associated with the value-added service deletion information among the client application programs of the plurality of value-added service information stored in the value-added service information storage;
if there are client application programs associated with the value-added service deletion information, acquiring menus associated with the client application programs from the value-added service information storage;
determining whether the menus associated with the value-added service deletion information have been displayed on the screen; and
if some of the menus have been displayed on the screen, removing the menus from the screen and deleting value-added service information associated with the menus, and if some of the menus associated with the value-added service deletion information have not been displayed on the screen, deleting the value-added service information associated with the value-added service deletion information.

15. The method of claim 10, wherein if the value-added service notice information is the value-added service update information, the determining of the menus comprises:
determining whether any client application program is associated with the value-added service update information among the client application programs of the plurality of value-added services stored in the value-added service information storage; and
if there are client application programs associated with the value-added service update information, updating the client application programs through the application server and updating value-added service information associated with the updated client application programs.
